(19) United States
(12) Patent Application Publication
(10) Pub. No.: US 2014/0240882 A1
(43) Pub. Date: Aug. 28, 2014

(54) SYSTEM FOR PROTECTING AND MONITORING A CIRCUIT FOR DISTRIBUTING DIRECT-CURRENT POWER

(71) Applicant: Stephane Hogg, Hindlingen (FR)

(72) Inventor: Stephane Hogg, Hindlingen (FR)

(73) Assignee: General Electric Company, Schenectady, NY (US)

(21) Appl. No.: 14/114,021

(22) PCT Filed: Apr. 25, 2012
(86) PCT No.: PCT/EP2012/057570

§ 371 Date: Apr. 17, 2014

(30) Foreign Application Priority Data
Apr. 26, 2011 (FR) 1153566

(51) Int. Cl. H02H 3/087; H02J 7/00

(52) U.S. Cl. CPC H02H 3/087; H02J 7/0031; H02J 2007/0039
USPC 361/87

(57) ABSTRACT

The invention relates to a system for protecting and monitoring a circuit for distributing direct current power, including at least one control cut-off element (3, 4) and at least one current sensor (7) inserted, in series, onto at least one conductor of the circuit (2) for distributing power, each control switch circuit (3) be operable by at least one control unit. The protection and monitoring system includes a protection device (1) linked at the input to current sensors (7) and at the output to the control unit (4), wherein the protection device (1) includes a control medium capable of tripping the opening of at least one control switch (3) in accordance with a measurement of the current received from a current sensor (7) inserted in a series in the control switch circuit (3).

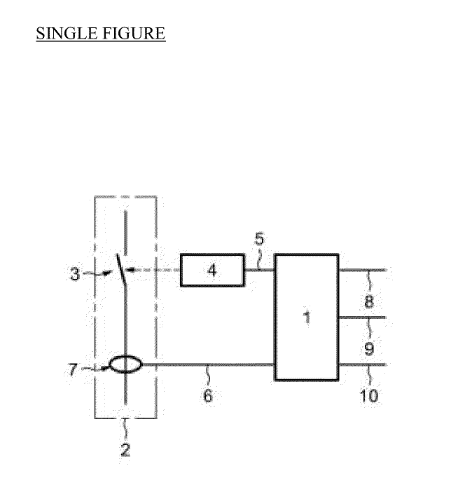

### BACKGROUND OF THE INVENTION

The invention relates to the field of systems to protect power supply and more specifically to systems to protect continuous power supply.

The protection of electrically powered equipment requires a balance between a satisfactory level of protection and the continuity of service in case of failure. A good balance is necessary all the more so as the protection is applied to direct current distribution systems, particularly for the distribution systems dedicated to the critical supply of battery-assisted equipment.

Such protection is currently provided by two solutions.

An initial solution is based on electromechanical fuses or circuit-breakers. This solution makes it possible to simply protect equipment in case of failure but does not allow total selectivity. In fact, the trigger time on a pure short-circuit (instantaneous or short-term trigger) is not adjustable. Moreover, it is not possible to distinguish the direction of the current.

A second solution is based on the association of sophisticated relays such as a monitoring relay and protection relay. Nevertheless, it is a complicated, cumbersome and expensive solution. In fact, the relays are intended for more complex applications. In other words, they include several unused functions for a high price.

The available solutions on the market are either too simple by not allowing total selectivity of direct current installations, or too complicated and thus incompatible from a technical-economic point of view.

### BRIEF SUMMARY OF THE INVENTION

An aspect of the invention relates to a protection system that gains total selectivity while remaining simple and economically viable.

Another aspect of the invention relates to a protection system that can be programmed remotely.

The aspect of the invention relates to a system to protect and monitor a direct current electrical energy distribution circuit including at least one required power cut element and at least a current sensor inserted in a series on at least a conductor of the electrical energy distribution circuit, whereby each required switch can be triggered by at least a control unit, whereby the protection system consists of a protection device at the input connected to the current sensors and at the output connected to the control unit. The protection device contains a control medium that is able to trigger the opening of at least a control switch in accordance with the measurement of the current received from a current sensor inserted in a series in the control switch circuit.

The control medium can be capable of triggering the opening of at least a control switch in accordance with the function of comparing the measurement of current received from a current sensor inserted in a series in the control switch circuit to at least at one defined threshold.

The control medium can be capable of triggering the opening of at least a control switch if the measurement of current received from a current sensor inserted in a series in the control switch circuit is strictly different from a defined threshold for a defined duration.

The defined duration can be a variable value function of the time and amplitude of the current.

The control medium can be capable of triggering the opening of at least a control switch in accordance with a defined threshold and defined duration that depend on the direction of circulation of the current received from a current sensor inserted in a series in the control switch circuit.

The protection device can be capable of polarizing at least one control unit with its internal source.

The protection device can consist of an input computer data link that is capable of modifying the defined thresholds and the defined durations.

The protection device can consist of an output computer data link that is capable of emitting the functionality parameters of the protection system intended for a distant user.

The system can consist of an analog output bearing at least a signal relating to the circulating instantaneous current in the conductor of the electrical energy distribution circuit.

The analog output can emit an analog current or voltage according to a maximum modifiable amplitude.

The system can consists of an energy storage medium that is capable of compensating for the normal supply of the protection and monitoring system.

The protection device can contain at least watch-dog output whereby the protection device is capable of emitting, in case of an incident, a signal by the watch-dog output that informs about a loss of supply or a problem on the protection device or a rupture in the link towards the current sensor or a rupture of the output computer data link or an insufficient reserve of energy in the energy storage medium.

The current sensor can be a Hall effect magnetometer.

The current sensor can be a device to measure the parallel voltage linked to a resistance.

Another objective of the invention relates to a process to protect an electrical energy distribution circuit consisting of at least a control cut-off element comprising each a control switch and at least a current sensor inserted in a series on at least an electrical energy distribution circuit in which the protection process includes phases during which: the opening of at least one control switch is controlled in accordance with the measurement of current received from a current sensor inserted in a series in the control switch circuit.

The opening of at least a control switch can be controlled in accordance with the comparison of the measurement of current received from a current sensor inserted in a series in the control switch circuit at defined thresholds.

The opening of at least a control switch can be controlled if the measurement of current received from a current sensor inserted in a series in the control switch circuit is strictly different from a defined threshold for a defined duration.

The defined duration can be a variable function value of the time and amplitude of the current.

The opening of at least a control switch can be controlled in accordance with a defined threshold and defined duration that depend on the direction of circulation of the current received from a current sensor inserted in a series in the control switch circuit.

Moreover, the protection system can be applied to protect the charge of a battery by a charger.

The defined threshold can correspond to a value of the charging current limit while the current circulates from the charger to the battery.

The defined threshold can correspond to a value of the short circuit current limit while the current circulates from the battery to the charger.

The defined duration while the current circulates from the charger to the battery and the defined duration while the current circulates from the battery to the charger can be different.

Other aspects, characteristics and advantages will appear upon reading the following description given uniquely as a non-limitative example and in reference to the annexed drawing on which the FIGURE illustrates a protection system according to the invention.

### BRIEF DESCRIPTION OF THE DRAWINGS

The single FIGURE shows a system to protect an energy distribution circuit consisting of a protection device 1 connected to a current sensor (probe) 7 by a connection 6 and to a control cut-off element 3, 4 by a connection 5.

### DETAILED DESCRIPTION OF THE INVENTION

The FIGURE shows a system to protect an energy distribution circuit consisting of a protection device 1 connected to a current sensor (probe) 7 by a connection 6 and to a control cut-off element 3, 4 by a connection 5.

Current sensor (probe) 7 can be of the Hall effect or shunt type. Shunt refers to a weak resistance value that is calibrated and inserted in a series in the conductor to be protected. The shunt, which is associated with a volt meter, makes it possible to determine the current circulating in the conductor without perturbing the electrical system linked to the conductor.

Control cut-off element 3, 4 consists of a control switch 3 activated by a trip coil 4. Connection 5 that originates from protection device 1 continues in the control cut-off element until trip coil 4. Trip coil 4 makes it possible to activate a control switch 3. Current sensor (probe) 7 and control switch 3 are connected in a series and are placed in a conductor of the distribution circuit. It is also possible to use several trip coils.

Connection 5 can be polarized by an internal source of the relay or can be supplied by an external source. Connection 5 can also be of the monostable or maintained type.

Connection 5 can also be associated with the same control to allow, for example, the simultaneous triggering of two control cut-off elements or the simultaneous tripping of two trip coils that are redundant and dependent on the same control cut-off element. Here, per control cut-off element, a switch controlled by one or several trip coils is presented. The control switch can also be a circuit-breaker.

Connection 5 can be associated with different controls to allow for example trips downstream/upstream. Inter-tripping downstream/upstream refers to the tripping of circuits that are connected downstream/upstream.

Protection device 1 can also be equipped with outputs 9 and 10 that make it possible to emit a signal towards a distance receiver to allow the transmission of functionality parameters, i.e., information on the operating state of the protection device and on the status of the alarms.

In this context, we can cite the status of the watch-dog, lack of monitoring of the measurement loop, lack of monitoring of the trip loop, under voltage, normal functionality, failure or tripping of the control switch.

One of the information outputs can be connected to a set of indicators or to an alphanumerical display that makes it possible to display the functionality status and status of the alarms.

The alphanumerical display can also display the measured instantaneous current and allow navigating in the parameterization menu. The current that circulates in the conductor and having caused a trip is memorized in the protection device and displayed after the trip.

Protection device 1 also includes an output computer connection that makes it possible to obtain information remotely relating to the status of functionality, the status of the alarms and generally the functionality parameters cited above. The computer connection can also be on the input side to allow control to parameterize or trip the protection device remotely. The computer connection, whether on the input side or output side or bidirectional, can use the Modbus, Profibus, DP, IEC 61850, Fieldbusfondation protocol or any adapted protocol.

Protection device 1 includes a supply connection 8 that allows it to be supplied with direct current or alternating current with strong amplitude, for example, from 20V to 265V.

The level of supply of protection device 1 is equipped with an anti-return system and integrated reserve of energy that allows the continuity of service in case of a loss or short-circuiting of its supply. The integrated reserve of energy is dimensioned to ensure the continuity of the functionality of protection device 1 for several minutes while the relay is idle, or to ensure the supply of the protection device during several successive trips.

The protection device can also be equipped with a second supply source that is redundant in relation to the supply source and takes the relay during the failure or exhaustion of this source.

The protection device can also be regulated according to several parameters.

The number of trip thresholds can also be regulated.

The current value of the trip thresholds can be regulated, for example, from a few mA to a few kA.

The value of the duration during which the trip thresholds are exceeded can be regulated, for example, from a few milliseconds to several minutes.

The type of curve can be regulated, for example, from constant time to dependent time.

Constant time refers to the fact that the tripping will take place after a set time whatever the amplitude of the exceeded current is.

Dependent time refers to the fact that the tripping time varies in function of the amplitude of the defined exceeded current according to a formula.

Each output can be assigned to different alarm or trip controls. These different controls can be realized locally by means of control buttons and display devices, or by a computer connection. The computer connection can be local, for example, of the RS 232 type, or remotely.

A library consisting of common values of different controls can be included in the protection device.

Moreover, the protection device is equipped with galvanic insulation between the inputs, outputs and supply source, and equipped with password-protected controls, a user interface in several languages.

According to an application, the protection device is placed between a charger and a battery.

The protection device measures the current of the battery by means of a shunt. It should be recalled that measurement of a current by a shunt implies the measurement of the voltage in the terminals with a resistance in which the current to be measured circulates. The current is thus determined by realizing the relationship between the voltage by the value of the resistance. It can also trip the control cut-off element of the battery equipped with a trip coil following two different thresholds, in function of the direction of the current, the technology and capacity of the battery.

In the direction from battery to charger, the relay trips the control cut-off element as soon as the current exceeds the maximum charge current in amplitude and for a programmed duration. The battery is thus protected by a possible surcharge in case of failure to regulate the charger.

In the direction from battery to charger, the relay trips the control cut-off element as soon as the current of the battery approaches its short-circuit current for a defined delay time allowing the other protections to insulate the circuit in close proximity to the failure. This action is selective in the direction in which the control cut-off element that insulates the battery will only be tripped if the failure cannot be eliminated by the other protections downstream.

According to a particular implementation application, a device to protect the universal battery is associated to a shunt in order to measure the intensity of the current in any range of values. The protection device consists of three control outputs of a switch and analog output that make it possible to obtain the measurements realized by the protection device. The protection device can ensure bidirectional control of the current that circulates between a battery and a charger. The protection device ensures a control of the charge current of the battery and a control of the current produced by it.

The protection thresholds and timeouts can be configured in an independent manner for each direction of current (charge and discharge). The protection device makes it possible to prevent short-circuits in the two directions and to impose a current limit. The protection device is thus compatible with all types of batteries.

Two control outputs of the protection device allow the protection in the current. These outputs are polarized, for example, under 24V, by the protection device and allow a direct control of a trip coil.

The third control output is affected at the watchdog.

This output is normally closed. When it is active, it allows for a loss of supply, a problem on the relay, a rupture of the link towards the measurement shunt, a rupture of the output control circuit or an insufficient reserve of energy to be signaled.

The protection device is equipped with an energy storage medium, for example, in the form of a battery allows a normal functionality for at least thirty seconds.

1. A protection and monitoring system for a direct current electrical energy distribution circuit having at least one control switch (3) and at least one current sensor (7) inserted, in series, in at least one conductor of the direct current electrical energy distribution circuit (2), comprising:
at least one control unit (4) capable of activating the control switch; and
a protection device (1) having an input linked to the at least one current sensor (7) and an output linked to the at least one control unit (4), wherein the protection device (1) includes a control medium capable of triggering the opening of the at least one control switch (3) depending on a current measurement received from the current sensor (7).

2. The system according to claim 1, wherein the control medium is capable of tripping an opening of the at least one control switch circuit (3) in accordance with a comparison of the current measurement received from a current sensor (7) with at least a defined threshold.

3. The system according to claim 2, wherein the control medium is capable of tripping the opening of at least one control switch (3) if the current measurement is strictly different from a defined threshold for a defined duration.

4. The system according to claim 3, wherein the defined period is a variable value function of the time and amplitude of the current measurement.

5. The system according to claim 3, wherein the control medium is capable of tripping the opening of at least one control switch (3) in accordance with the defined threshold and defined duration dependent on the direction of the current measurement received from the current sensor (7).

6. The system according to claim 1, wherein the protection device (1) is capable of polarizing the at least one control unit (4) with an internal source of the protection device.

7. The system according to claim 5, wherein the protection device includes an input computer link of data capable of modifying the defined threshold and defined duration.

8. The system according to claim 1, wherein the protection device includes an output computer link of data capable of emitting functionality parameters of the protection device intended for a remote user.

9. The system according to claim 1, further comprising an analog output bearing at least a signal relating to an instantaneous current circulating in the conductor of the direct current electrical energy distribution circuit (2).

10. The system according to claim 9, wherein the analog output emits an analog current or voltage according to a maximum modifiable amplitude.

11. The system according to claim 10, further comprising an energy storage medium capable of compensating for a normal supply of the protection and monitoring system.

12. The system according to claim 11, wherein the protection device (1) includes at least a watchdog type output, whereby the protection device (1) is capable of emitting, in case of an incident, a signal by the watchdog type output that informs about: a loss of supply, a problem on the protection device (1), a rupture in the link towards the current sensor (7), a rupture of the output computer data link, or an insufficient reserve of energy in the energy storage medium.

13. The system according to claim 1, wherein the current sensor (7) is a current sensor of the Hall effect type.

14. The system according to claim 1, wherein the current sensor (7) is a voltage measuring device with a parallel connection to a resistance.

15. A method to protect a direct current distribution circuit that includes at least one control switch (3) and at least one current sensor (7) inserted in series on at least one conductor of the direct current distribution circuit (2), wherein the protection method comprises:
providing a protection device (1) having an input linked to the at least one current sensor (7) and an output linked to the at least one control unit (4);
measuring the current received from the at least one current sensor (7); and
controlling an opening of the at least one control switch (3) with the protection device based on a measurement of current received from the at least one current sensor (7).

16. The method according to claim 15, wherein the opening of the at least one control switch (3) is in accordance with a comparison of the measurement of current received from the at least one current sensor at defined thresholds.

17. The method according to claim 16, wherein the opening of the at least one control switch (3) is made if the measurement of current is strictly different from a defined threshold for a defined duration.

18. The method according to claim 17, wherein the defined duration is a variable function value of a time and amplitude of the current.

19. The method according to claim 18, wherein the opening of the at least one control switch (3) is made in accordance with the defined threshold and defined duration dependent on the direction of circulation of the current received from the at least one current sensor (7).

20. The method according to claim 19, wherein the direct current electrical energy distribution circuit includes a battery and a charger for the battery.

21. The method according to claim 20, wherein the defined threshold corresponds to a value of a limit charge current while the current circulates from the charger to the battery.

22. The method according to claim 20, wherein the defined threshold corresponds to a value of a short-circuit current limit while the current circulates from the battery to the charger.

23. The method of claim 22, wherein the defined duration while the current circulates from the charger to the battery and the defined duration while the current circulates from the battery to the charger are different.
